(19) United States
(12) Patent Application Publication
(10) Pub. No.: US 2025/0304389 A1
(43) Pub. Date: Oct. 2, 2025

(54) MEASURING SYSTEM AND IMAGE FORMING SYSTEM

(71) Applicant: FUJIFILM Business Innovation Corp., Tokyo (JP)

(72) Inventors: Kenichi ITO, Kanagawa (JP); Kouhei YUKAWA, Kanagawa (JP); Yoshinori SHIRAKAWA, Kanagawa (JP); Kyoji YAGI, Kanagawa (JP)

(73) Assignee: FUJIFILM Business Innovation Corp., Tokyo (JP)

(21) Appl. No.: 18/786,968

(22) Filed: Jul. 29, 2024

(30) Foreign Application Priority Data
Mar. 27, 2024 (JP) 2024-052307

(51) Int. Cl. B65H 7/14; B65H 7/20

(52) U.S. Cl. CPC B65H 7/14; B65H 7/20; B65H 2553/21; B65H 2553/30; B65H 2553/412

(57) ABSTRACT

A measuring system includes a first light emitter that emits light toward a measurement target; a first light receiver that receives light transmitted through the measurement target; a measuring unit that measures at least one of an electrical resistance and a transmittance of ultrasonic waves of the measurement target; and a processor configured to determine, based on a size of the light received by the first light receiver and a result of measurement by the measuring unit, whether or not the measurement target is an object with a high optical transmittance or whether or not the measurement target is present in a measurement region.

### CROSS-REFERENCE TO RELATED APPLICATIONS

This application is based on and claims priority under 35 USC 119 from Japanese Patent Application No. 2024-052307 filed Mar. 27, 2024.

### BACKGROUND

### (i) Technical Field

The present disclosure relates to a measuring system and an image forming system.

### (ii) Related Art

In Japanese Unexamined Patent Application Publication No. 6-40605, a recording member determining apparatus including a reflection-type detector that detects light reflected on a surface of a detection object, a transmission-type detector that detects whether or not the detection object transmits light, and determining means for determining the type of the detection object by receiving a detection signal from the reflection-type detector and a detection signal from the transmission-type detector at different times, is disclosed.

In Japanese Unexamined Patent Application Publication No. 2020-100490, an image forming apparatus including transport means for transporting a medium on which an image is to be formed, a first detector that detects the basis weight of the medium transported by the transport means, a second detector that detects that the type of the medium transported by the transport means is an envelope, and determining means for determining, based on a result of detection by the second detector, whether or not detection of the basis weight of the medium by the first detector is to be performed or whether or not a result of the detection by the first detector is to be used, is disclosed.

In Japanese Unexamined Patent Application Publication No. 2003-40487, a sheet determining apparatus in which a light emitting element that radiates light to a surface of a sheet and a light receiving element that receives light reflected from the surface of the sheet are arranged in such a manner that specularly reflected light from the surface of the sheet is not directly received by the light receiving element, is disclosed. At least one of an optical axis of the light emitting element and an optical axis of the light receiving element is tilted with respect to the surface of the sheet by a predetermined angle so that the optical axis of the light receiving element is not located within a plane formed by the optical axis of the light emitting element and light radiated from the light emitting element and specularly reflected on the surface of the sheet.

### SUMMARY

Aspects of non-limiting embodiments of the present disclosure relate to distinguishing between a case where a measurement target has a high optical transmittance and a case where a measurement target is not present in a measurement region.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a measuring system including a first light emitter that emits light toward a measurement target; a first light receiver that receives light transmitted through the measurement target; a measuring unit that measures at least one of an electrical resistance and a transmittance of ultrasonic waves of the measurement target; and a processor configured to determine, based on a size of the light received by the first light receiver and a result of measurement by the measuring unit, whether or not the measurement target is an object with a high optical transmittance or whether or not the measurement target is present in a measurement region.

### BRIEF DESCRIPTION OF THE DRAWINGS

Exemplary embodiments of the present disclosure will be described in detail based on the following figures, wherein:

FIG. 1 is a block diagram illustrating a configuration of an image forming apparatus according to an exemplary embodiment;

FIG. 2 is a schematic diagram illustrating a configuration of a measuring device according to an exemplary embodiment;

FIG. 3 is a block diagram illustrating an example of the hardware configuration of a control circuit in an exemplary embodiment;

FIG. 4 is a block diagram illustrating an example of the functional configuration of a processor of the control circuit in the exemplary embodiment;

FIG. 5 is a flowchart illustrating a flow of a control process in an exemplary embodiment;

FIG. 6 is a graph indicating the relationship between the optical transmittance and the electrical resistance value of paper;

FIG. 7 is a graph indicating the relationship between the optical transmittance and the basis weight of paper; and

FIG. 8 is a flowchart illustrating a flow of a control process in another exemplary embodiment.

### DETAILED DESCRIPTION

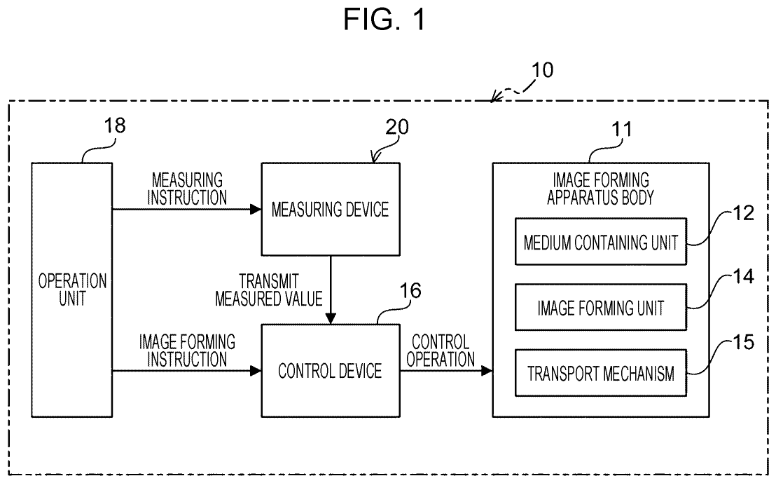

An image forming apparatus 10 as an example of an image forming system and a measuring device 20 as an example of a measuring system according to an exemplary embodiment of the present disclosure will be described with reference to FIGS. 1 to 5. First, the image forming apparatus 10 will be described.

(Image forming apparatus 10)

FIG. 1 is a block diagram illustrating a configuration of the image forming apparatus 10 according to an exemplary embodiment.

The image forming apparatus 10 is an apparatus that forms an image on paper P as a recording medium. Specifically, as illustrated in FIG. 1, the image forming apparatus 10 includes an image forming apparatus body 11, a medium containing unit 12, an image forming unit 14, a transport mechanism 15, a control device 16, the measuring device 20, and an operation unit 18. Components of the image forming apparatus 10 will be described below.

(Image forming apparatus body 11)

Component units of the image forming apparatus 10 are provided in the image forming apparatus body 11 illustrated in FIG. 1. Specifically, the image forming apparatus body 11 includes, for example, a housing with a box shape. In this exemplary embodiment, the medium containing unit 12, the image forming unit 14, and the transport mechanism 15 are provided inside the image forming apparatus body 11.

(Medium containing unit 12)

The medium containing unit 12 illustrated in FIG. 1 is a unit in which paper P is accommodated in the image forming apparatus 10. The paper P accommodated in the medium containing unit 12 is supplied to the image forming unit 14.

(Image forming unit 14)

The image forming unit 14 illustrated in FIG. 1 has a function for forming an image on the paper P supplied from the medium containing unit 12. The image forming unit 14 is, for example, an image forming unit of an inkjet type that forms an image on the paper P using ink, an image forming unit of an electrophotographic type that forms an image on the paper P using toner, or the like.

For example, the image forming unit of the inkjet type discharges ink drops onto the paper P from a discharge part to form an image on the paper P. The image forming unit of the inkjet type may form an image on the paper P by discharging ink drops to a transfer body from a discharge part and transferring the ink drops from the transfer body to the paper P.

For example, the image forming unit of the electrophotographic type performs steps of charging, exposure, developing, transfer, and fixing to form an image on the paper P. The image forming unit of the electrophotographic type may form an image on the paper P by performing steps of charging, exposure, developing, and transfer to form an image on the transfer body, transferring the image onto the paper P from the transfer body, and then fixing the image onto the paper P.

The image forming unit is not limited to, for example, the image forming unit of the inkjet type described above or the image forming unit of the electrophotographic type described above. The image forming unit may be any type of image forming unit.

(Transport mechanism 15)

The transport mechanism 15 illustrated in FIG. 1 is a mechanism for transporting the paper P. For example, the transport mechanism 15 causes a transport member (not illustrated in FIG. 1) such as a transport roller, a transport belt, and the like to transport the paper P. The transport mechanism 15 transports the paper P through a predetermined transport path from the medium containing unit 12 to the image forming unit 14.

(Operation unit 18)

The operation unit 18 illustrated in FIG. 1 is a device that a user of the image forming apparatus 10 operates and transmits, for example, a measuring instruction to the measuring device 20 or an image forming instruction to the control device 16 in accordance with an operation by the user. The operation unit 18 includes, for example, an operation panel such as a touch display. In the example illustrated in FIG. 1, the operation unit 18 is provided separately from the image forming apparatus body 11. However, the operation unit 18 may be provided in the image forming apparatus body 11.

(Overview of control device 16 and measuring device 20)

As illustrated in FIG. 1, for example, the measuring device 20 and the control device 16 are provided outside the image forming apparatus body 11. The control device 16 includes a controller (control substrate). The controller includes a recording unit including a storage in which a program is recorded and a processor configured to operate in accordance with the program.

In this exemplary embodiment, for example, the user of the image forming apparatus 10 places the paper P, on which an image is to be formed, at the measuring device 20, and causes the operation unit 18 to issue a measuring instruction. When acquiring the measuring instruction from the operation unit 18, the measuring device 20 performs, based on preset items, measurement of the paper P and stores measured value information into a memory 82 or a storage 83.

For example, the user of the image forming apparatus 10 causes the paper P measured by the measuring device 20 to be accommodated in the medium containing unit 12 and causes the operation unit 18 to issue an image forming instruction. The image forming instruction may contain a measuring instruction.

When acquiring the image forming instruction from the operation unit 18, the control device 16 causes the image forming unit 14 and the transport mechanism 15 to perform an image forming operation and controls, based on the measured value information, operation of the image forming unit 14 and the transport mechanism 15. Specifically, the control device 16 controls, based on the measured value information, transport speed of the paper P by the transport mechanism 15, transfer voltage and fixing temperature by the image forming unit 14, and the like. However, the present disclosure is not limited to the configuration described above.

In the example described above, the control device 16 is provided outside the image forming apparatus body 11. However, the control device 16 may be provided inside the image forming apparatus body 11. Furthermore, the control device 16 may acquire measured value information directly from the measuring device 20.

Furthermore, in the example described above, the measuring device 20 is provided outside the image forming apparatus body 11. However, the measuring device 20 may be provided inside the image forming apparatus body 11. Specifically, the measuring device 20 may be configured as a device that performs, based on preset items, measurement of the paper P in the medium containing unit 12 or on the transport path for the paper P.

(Specific configuration of measuring device 20)

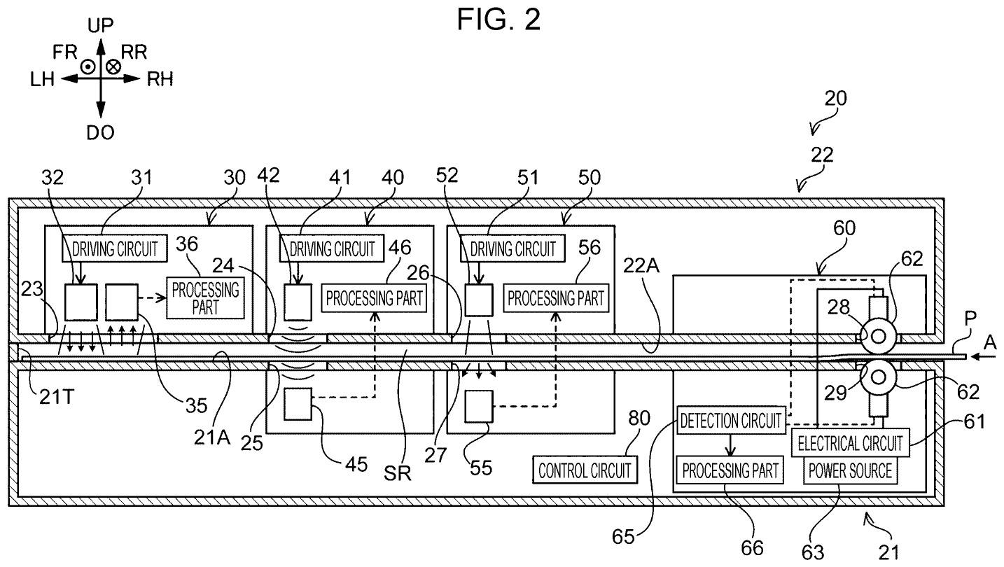

FIG. 2 is a schematic diagram illustrating a configuration of the measuring device 20 according to an exemplary embodiment. In FIG. 2, an arrow UP indicates an upper direction (vertically upper direction) of the device, an arrow FR indicates a front direction of the device, and an arrow RR indicates a rear direction of the device. The directions mentioned above are set for convenience of explanation. Hence, the device configuration is not limited to the directions mentioned above. In each of the directions of the device, the term “device” may be omitted. That is, for example, an “upper direction of the device” may be simply expressed as an “upper direction”.

Furthermore, in the description provided below, an “upper-lower direction” may represent “both upper and lower directions” or “an upper direction or a lower direction”. A “Left-right direction” may represent “both right and left directions” or “a right direction or a left direction”. The “left-right direction” may also represent a lateral direction or a horizontal direction. A “Front-rear direction” may represent “both front and rear directions” or “a front direction or a rear direction”. The “front-rear direction” may also represent a lateral direction or a horizontal direction. Furthermore, the upper-lower direction, the left-right direction, and the front-rear direction intersect one another (specifically, are orthogonal to one another).

In FIG. 2, a circle with “x” at its center represents an arrow indicating a direction from a front side toward a back side on the plane of the sheet of FIG. 2. Furthermore, in FIG. 2, a circle with “.” at its center represents an arrow indicating a direction from the back side toward the front side on the plane of the sheet of FIG. 2.

Throughout the drawings, component elements denoted by the same signs represent the same or similar component elements. In exemplary embodiments described below, repetitive description and use of signs may be omitted. Furthermore, drawings used in the description provided below are schematic and the relationship between dimensions of elements, the ratio of elements, and the like illustrated in the drawings do not necessarily match the actual ones. The relationship between dimensions of elements, the ratio of elements, and the like are not necessarily the same between the drawings.

The measuring device 20 is a device that measures color information on paper P used in the image forming apparatus 10 and other values. Specifically, the measuring device 20 has a function for measuring color, optical transmittance, transmittance of ultrasonic waves, and electrical resistance of the paper P. The paper P is an example of a “measurement target”.

Specifically, the measuring device 20 includes a first housing 21, a second housing 22, a color measuring unit 30, an ultrasonic wave measuring unit 40, a transmitted light measuring unit 50, and a resistance measuring unit 60, as illustrated in FIG. 2. Components of the measuring device 20 will be described below.

(First housing 21)

Part of the components of the measuring device 20 is provided in the first housing 21. The first housing 21 configures a lower part of the measuring device 20. The first housing 21 has an opposing surface 21A that faces the lower surface of the paper P. The opposing surface 21A also serves as a supporting surface (holding surface) that supports (holds) the paper P from the lower side. The opposing surface 21A is an example of a “holder”. Part of the ultrasonic wave measuring unit 40, part of the transmitted light measuring unit 50, and part of the resistance measuring unit 60 are arranged inside the first housing 21.

(Second housing 22)

The remaining part of the components of the measuring device 20 is provided in the second housing 22. The second housing 22 configures an upper part of the measuring device 20. The second housing 22 has an opposing surface 22A that faces the upper surface of the paper P. The color measuring unit 30, the remaining part of the ultrasonic wave measuring unit 40, the remaining part of the transmitted light measuring unit 50, and the remaining part of the resistance measuring unit 60 are arranged inside the second housing 22. In the measuring device 20, the paper P, which is an example of a measurement target, is set from a direction indicated by an arrow A (hereinafter, appropriately referred to as a “set direction”) between the first housing 21 and the second housing 22. A space in which the paper P is set for measurement between the first housing 21 and the second housing 22 will be referred to as a set part SR. The region of the paper P set in the set part SR will be referred to as a measurement region. An abutment part 21T as a reference for setting the paper P to the set part SR is provided at the back of the set part SR.

For example, the second housing 22 is configured to be relatively movable in directions approaching and receding from the first housing 21 (specifically, the upper-lower direction) and, after the paper P is arranged between the first housing 21 and the second housing 22, to relatively move in the direction approaching the first housing 21 to be located at the position illustrated in FIG. 2.

(Color measuring unit 30)

The color measuring unit 30 illustrated in FIG. 2 has a function for measuring the color of the paper P. Specifically, the color measuring unit 30 includes a driving circuit 31, a light radiating part 32, a light receiving part 35, and a processing part 36, as illustrated in FIG. 2. The light radiating part 32 is an example of a “second light emitter”. The light receiving part 35 is an example of a “second light receiver”.

The light radiating part 32 has a function for emitting light of different wavelengths toward the paper P, that is, radiating light of different wavelengths to the paper P. Specifically, the light radiating part 32 radiates light of wavelengths corresponding to R (red), G (green), and B (blue) to the paper P. The light radiating part 32 is arranged in the second housing 22. That is, the light radiating part 32 is arranged at a position facing one surface (specifically, the upper surface) of the paper P with a space interposed therebetween. An opening 23 through which light from the light radiating part 32 is transmitted to the paper P is formed at a position lower than the light radiating part 32 in the second housing 22.

The driving circuit 31 is a circuit that drives the light radiating part 32. When the driving circuit 31 drives the light radiating part 32, the light radiating part 32 radiates light to the paper P and the light is reflected on the paper P.

The light receiving part 35 has a function for receiving reflection light reflected by the paper P. The light receiving part 35 is arranged in the second housing 22. That is, the light receiving part 35 is arranged at a position facing one surface (specifically, the upper surface) of the paper P with a space interposed therebetween. The light receiving part 35 receives reflection light reflected by the paper P to generate a light reception signal. The opening 23 extends at the position lower than the light receiving part 35 in the second housing 22, and light from the paper P side is transmitted through the opening 23 to the light receiving part 35.

As described above, in the color measuring unit 30, the light radiating part 32 and the light receiving part 35 form a detector (specifically, a detection sensor) that detects color information on the paper P (specifically, reflection light reflected by the paper P). The driving circuit 31 is a circuit that drives the detector.

The processing part 36 performs processing such as amplification for a light reception signal acquired from the light receiving part 35 to obtain a measured value. Furthermore, the processing part 36 stores measured value information, which is the obtained color information, into the memory 82 or the storage 83. The processing part 36 includes, for example, an electrical circuit including an amplifier circuit.

(Ultrasonic wave measuring unit 40)

The ultrasonic wave measuring unit 40 illustrated in FIG. 2 has a function for measuring the transmittance of ultrasonic waves of the paper P. Specifically, the ultrasonic wave measuring unit 40 has a function for vibrating the paper P by application of ultrasonic waves and measuring presence or absence of the paper P. The ultrasonic wave measuring unit 40 is an example of a “measuring unit”.

As illustrated in FIG. 2, the ultrasonic wave measuring unit 40 includes a driving circuit 41, an emitting part 42, a receiving part 45, and a processing part 46.

The emitting part 42 has a function for emitting ultrasonic waves toward the paper P, that is, emitting ultrasonic waves to the paper P. The emitting part 42 is arranged in the second housing 22. That is, the emitting part 42 is arranged at a position facing one surface (specifically, the upper surface) of the paper P. An opening 24 through which ultrasonic waves from the emitting part 42 are transmitted to the paper P is formed at a position lower than the emitting part 42 in the second housing 22.

The driving circuit 41 is a circuit that drives the emitting part 42. When the driving circuit 41 drives the emitting part 42, the emitting part 42 applies ultrasonic waves from the upper surface side of the paper P so that the paper P vibrates. The paper P that has been made to vibrate vibrates air on the side lower than the paper P. In other words, ultrasonic waves from the emitting part 42 are transmitted through the paper P.

The receiving part 45 has a function for receiving ultrasonic waves transmitted through the paper P. The receiving part 45 is arranged in the first housing 21. That is, the receiving part 45 is arranged at a position facing the other surface (specifically, the lower surface) of the paper P. The receiving part 45 receives ultrasonic waves transmitted through the paper P to generate a reception signal. An opening 25 through which ultrasonic waves from the paper P side are transmitted to the receiving part 45 is formed at a position upper than the receiving part 45 in the first housing 21.

As described above, in the ultrasonic wave measuring unit 40, the emitting part 42 and the receiving part 45 form a detector (specifically, a detection sensor) that detects information indicating the basis weight of the paper P (specifically, ultrasonic waves transmitted through the paper P). The driving circuit 41 is a circuit that drives the detector.

The processing part 46 performs processing such as amplification for a reception signal acquired from the receiving part 45 to obtain a measured value. Furthermore, the processing part 46 stores measured value information indicating the obtained transmittance of ultrasonic waves into the memory 82 or the storage 83. The processing part 46 includes, for example, an electrical circuit including an amplifier circuit.

(Transmitted light measuring unit 50)

The transmitted light measuring unit 50 illustrated in FIG. 2 has a function for measuring the transmittance of the paper P. Specifically, as illustrated in FIG. 2, the transmitted light measuring unit 50 includes a driving circuit 51, a light radiating part 52, a light receiving part 55, and a processing part 56. The light radiating part 52 is an example of a “first light emitter”. Furthermore, the light receiving part 55 is an example of a “first light receiver”.

The light radiating part 52 has a function for emitting light toward the paper P, that is, radiating light to the paper P. The light radiating part 52 is arranged in the second housing 22. That is, the light radiating part 52 is arranged at a position facing one surface (specifically, the upper surface) of the paper P with a space interposed therebetween. An opening 26 through which light from the light radiating part 52 is transmitted to the paper P is formed at a position lower than the light radiating part 52 in the second housing 22.

The driving circuit 51 is a circuit that drives the light radiating part 52. When the driving circuit 51 drives the light radiating part 52, the light radiating part 52 radiates light to the paper P.

The light receiving part 55 has a function for receiving light transmitted through the paper P. The light receiving part 55 is arranged in the first housing 21. That is, the light receiving part 55 is arranged at a position facing the other surface (specifically, the lower surface) of the paper P with a space interposed therebetween. The light receiving part 55 receives light transmitted through the paper P to generate a light reception signal. An opening 27 through which light from the paper P side is transmitted to the light receiving part 55 is formed at a position upper than the light receiving part 55 in the first housing 21.

As described above, in the transmitted light measuring unit 50, the light radiating part 52 and the light receiving part 55 form a detector (specifically, a detection sensor) that detects information on the transmittance of the paper P (specifically, reflection light reflected by the paper P). The driving circuit 51 is a circuit that drives the detector.

The processing part 56 performs processing such as amplification for a light reception signal acquired from the light receiving part 55 to obtain a measured value. Furthermore, the processing part 56 stores measured value information indicating the obtained optical transmittance into the memory 82 or the storage 83. The processing part 56 includes, for example, an electrical circuit including an amplifier circuit.

(Resistance measuring unit 60)

The resistance measuring unit 60 illustrated in FIG. 2 has a function for measuring the electrical resistance (in this exemplary embodiment, a volume resistance value [Ω]) of the paper P. The resistance measuring unit 60 is an example of a “measuring unit”.

As illustrated in FIG. 2, the resistance measuring unit 60 includes an electrical circuit 61, a pair of terminals 62, a power source 63, a detection circuit 65, and a processing part 66. The pair of terminals 62 is an example of a “pair of electrodes”).

One of the pair of terminals 62 is arranged in the first housing 21, and the other one of the pair of terminals 62 is arranged in the second housing 22. Specifically, the one of the pair of terminals 62 is in contact with the lower surface of the paper P through an opening 29 that is formed in the first housing 21, and the other one of the pair of terminals 62 is in contact with the upper surface of the paper P through an opening 28 that is formed in the second housing 22. Thus, the paper P is sandwiched between the pair of terminals 62 in the upper-lower direction. For example, one of the pair of terminals 62 may be biased toward the other one of the pair of terminals 62. By causing one of the pair of terminals 62 to be biased toward the other one of the pair of terminals 62 as mentioned above, the paper P is easily sandwiched between the pair of terminals 62. Furthermore, the paper P may be made to be sandwiched between the pair of terminals 62 after the paper P is inserted between the first housing 21 and the second housing 22 or the paper P may be inserted into a part where the terminals 62 are made in contact with each other in advance. Each of the terminals 62 is electrically connected to the power source 63 with the electrical circuit 61 interposed therebetween.

The power source 63 applies a predetermined voltage ([V]) to the pair of terminals 62 through the electrical circuit 61. Thus, a current corresponding to a body surface resistance value flows inside the paper P that is located between the terminals 62. The detection circuit 65 is electrically connected to the pair of terminals 62. The detection circuit 65 detects a current flowing between the terminals 62 to generate a detection signal.

As described above, in the resistance measuring unit 60, the pair of terminals 62 and the detection circuit 65 form a detector (specifically, a detection sensor) that detects information indicating the volume resistance of the paper P (specifically, a current flowing in the paper P). The electrical circuit 61 includes a circuit that drives the detector.

The processing part 66 performs processing such as amplification for a detection signal acquired from the detection circuit 65 to obtain a measured value (specifically, a current value [A]). Furthermore, the processing part 66 stores information indicating the obtained electrical resistance value into the memory 82 or the storage 83. The processing part 66 includes, for example, an electrical circuit including an amplifier circuit.

Although the resistance measuring unit 60 is configured to apply a predetermined voltage to the pair of terminals 62 and detect a current flowing between the terminals 62 to obtain a volume resistance value, the present disclosure is not limited to the configuration described above. For example, a volume resistance value may be obtained by causing a current corresponding to a predetermined current value to flow to the pair of terminals 62 and detecting the voltage between the terminals 62.

(Control circuit 80)

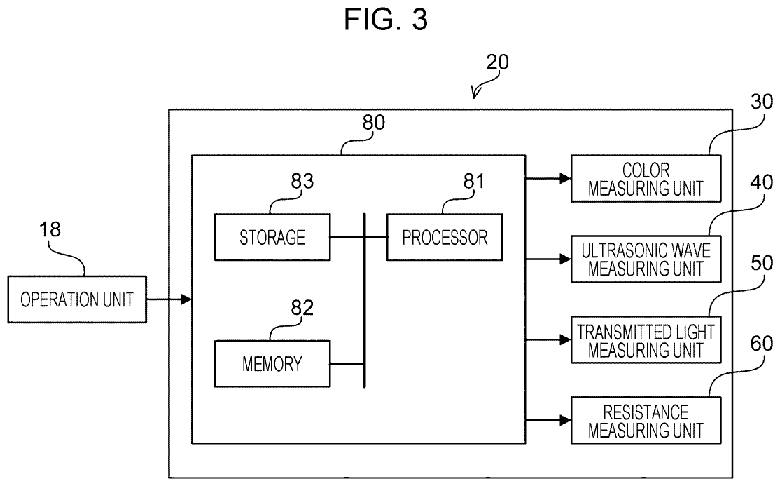

The control circuit 80 has a control function for controlling operation of the individual units (the color measuring unit 30, the ultrasonic wave measuring unit 40, the transmitted light measuring unit 50, and the resistance measuring unit 60) of the measuring device 20. Specifically, as illustrated in FIG. 3, the control circuit 80 includes a processor 81, the memory 82, and the storage 83.

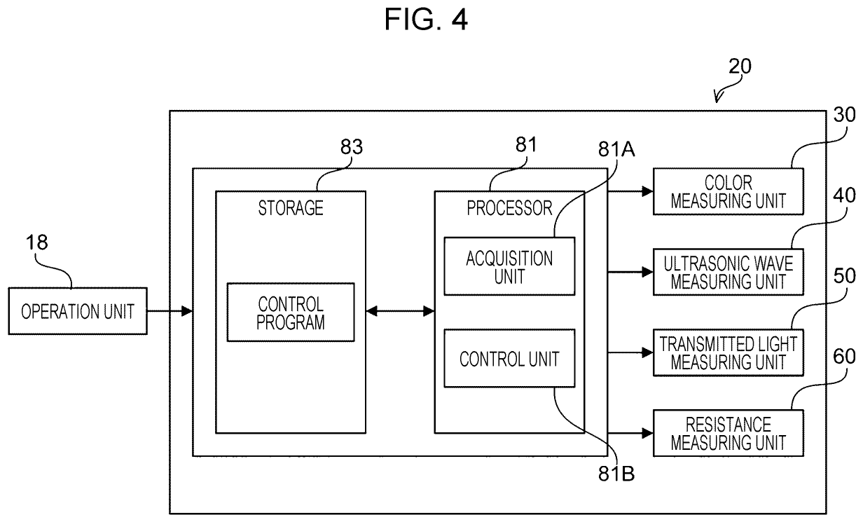

Various programs including a control program 83A (see FIG. 4) and various data are stored in the storage 83. The storage 83 is implemented by, for example, a recording device such as a hard disk drive (HDD), a solid state drive (SSD), or a flash memory.

The memory 82 is a work area in which the processor 81 executes various programs. Various programs or various data are temporarily recorded in the memory 82 when the processor 81 performs processing. The processor 81 reads various programs including the control program 83A from the storage 83 onto the memory 82 and executes a program using the memory 82 as a work area.

In the control circuit 80, the processor 81 implements various functions by executing the control program 83A. A functional configuration implemented by collaboration between the processor 81 as a hardware resource and the control program 83A as a software resource will be described below. FIG. 4 is a block diagram illustrating a functional configuration of the processor 81.

As illustrated in FIG. 4, in the control circuit 80, the processor 81 functions as an acquisition unit 81A and a control unit 81B by executing the control program 83A. The acquisition unit 81A acquires a measuring instruction for measuring the paper P from the operation unit 18.

When the acquisition unit 81A acquires a measuring instruction, the control unit 81B performs, for each measuring unit, measuring control for measuring the paper P.

In this exemplary embodiment, in the measuring control, the determination as to whether or not the paper P has a high optical transmittance or whether or not the paper P is present in the measurement region is performed, based on the size of light received by the light receiving part 35 and a measurement result of the electrical resistance or the transmittance of ultrasonic waves.

Specifically, the control unit 81B drives the color measuring unit 30 to acquire the color of the paper P. More specifically, the control unit 81B determines, based on the wavelength and the strength of reflection light by the paper P, the color of the paper P.

The control unit 81B acquires in advance the color of the opposing surface 21A. In the case where the acquired color of the opposing surface 21A matches the determined color of the paper P, it is determined that there is a possibility that the paper P may be an object with a high optical transmittance or the paper P may be not present in the measurement region. When the result mentioned above is obtained, the control unit 81B causes the transmitted light measuring unit 50, the ultrasonic wave measuring unit 40, and the resistance measuring unit 60 to perform measurement.

The control unit 81B drives the transmitted light measuring unit 50 to obtain the optical transmittance of the paper P. The determination as to whether or not the paper P has a high optical transmittance is performed based on the obtained optical transmittance. For example, in the case where the optical transmittance of the paper P exceeds a predetermined threshold value, it is determined that the paper P is transparent.

Furthermore, the control unit 81B drives the ultrasonic wave measuring unit 40 to obtain the transmittance of ultrasonic waves of the paper P. The determination as to whether or not the paper P is present in the measurement region is performed based on the obtained transmittance of ultrasonic waves. For example, in the case where the transmittance of ultrasonic waves of the paper P exceeds a predetermined threshold value, it is determined that the paper P is not present in the measurement region. For example, regarding the determination based on basis weight, as illustrated in FIG. 7, in the case where the basis weight is less than a threshold value, it is determined that the paper P is not present in the measurement region.

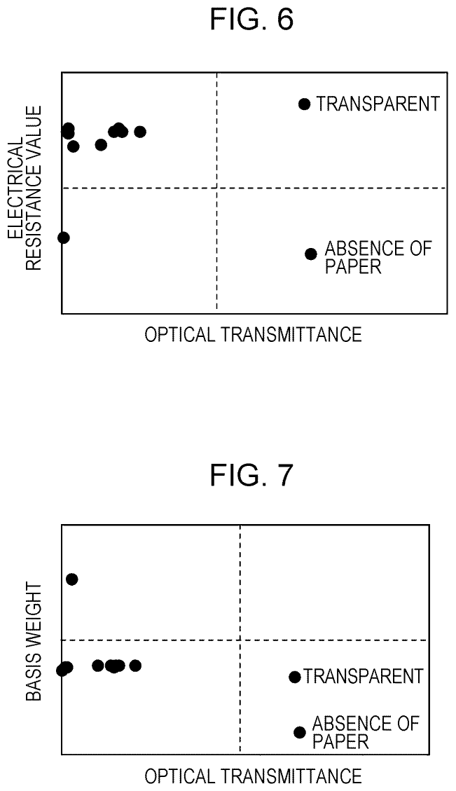

Furthermore, the control unit 81B drives the resistance measuring unit 60 to obtain the electrical resistance of the paper P. The determination as to whether or not the paper P is present in the measurement region is performed based on the obtained electrical resistance. For example, as illustrated in FIG. 6, in the case where the electrical resistance of the paper P is less than a predetermined threshold value (for example, a broken line in FIG. 6), it is determined that the paper P is not present in the measurement region.

In the case where the result of presence or absence of the paper P in the measurement region based on the electrical resistance of the paper P and the result of presence or absence of the paper P in the measurement region based on the transmittance of ultrasonic waves of the paper P are different, the control unit 81B compares the measurement position for the electrical resistance with the measurement position for the transmittance of ultrasonic waves in the measurement region to determine which one of the electrical resistance and the transmittance of ultrasonic waves is to be given priority. Specifically, the control unit 81B compares the measurement position for the electrical resistance with the measurement position for the transmittance of ultrasonic waves in the measurement region, and gives priority to a measurement position that is located closer to a side opposite the set direction A from which the paper P is set into the set part SR. In this exemplary embodiment, for example, the resistance measuring unit 60 is located closer to the initial point of the set direction A, that is, located closer to the side opposite the set direction A, than the ultrasonic wave measuring unit 40. Thus, the determination based on the electrical resistance is given priority.

The control unit 81B stores measurement results (also be referred to as determination results) obtained by the individual measurement units into the memory 82 or the storage 83.

(Operation in exemplary embodiment)

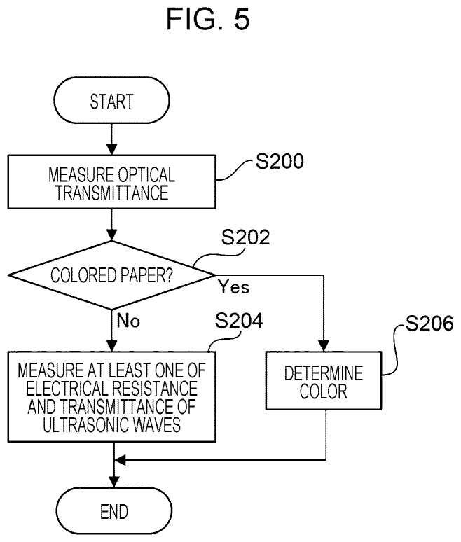

Next, an example of operation in an exemplary embodiment will be described. FIG. 5 is a flowchart illustrating the flow of a control process performed by the control circuit 80.

This process is performed when the processor 81 reads the control program 83A from the storage 83 and executes the control program 83A. For example, execution of this process starts when the processor 81 acquires a measuring instruction from the operation unit 18.

As illustrated in FIG. 5, in step S200, the processor 81 drives the ultrasonic wave measuring unit 40 to obtain the optical transmittance of the paper P.

In step S202, the processor 81 determines, based on the optical transmittance, whether or not the paper P is colored paper. In the case where it is determined that the paper P is not colored paper, the processor 81 proceeds to step S204. The paper P that is not colored paper may be thin paper such as a transparent film or tracing paper. In the case where it is determined that the paper P is colored paper, the processor 81 proceeds to step S206.

In step S204, the processor 81 drives at least one of the ultrasonic wave measuring unit 40 and the resistance measuring unit 60 to determine whether or not the paper P is present in the measurement region. In the case where the determination result is that the paper P is not present, the processor 81 causes the operation unit 18 to display, for example, an error message indicating that the paper P is not present. In contrast, in the case where the determination result is that the paper P is present, it is determined that the paper P is paper that is not colored paper. The processor 81 stores the result of the determination into the memory 82 or the storage 83 and ends measurement of the paper P.

In step S206, the processor 81 drives the color measuring unit 30 to obtain the color of the paper P. Specifically, the color of the paper P is determined based on reflection light by the paper P. The processor 81 stores the obtained color information on the paper P into the memory 82 or the storage 83 and ends measurement of the paper P.

In this exemplary embodiment, the processor 81 performs the determination as to whether or not the paper P has a high optical transmittance or the determination as to whether or not the paper P is present in the measurement region, based on the measurement result of the optical transmittance and the measurement result of at least one of the electrical resistance and the transmittance of ultrasonic waves. Thus, the case where the paper P has a high optical transmittance and the case where the paper P is not present in the measurement region are distinguished from each other.

In this exemplary embodiment, in the case where the processor 81 determines, based on the electrical resistance of the paper P, whether or not the paper P is present in the measurement region, presence or absence of the paper P is determined more accurately than the case where the presence or absence of the paper P is determined without contact.

In this exemplary embodiment, in the case where the processor 81 performs, based on the optical transmittance and the electrical resistance, the determination as to whether the paper P is an object with a high optical transmittance or the paper P is not present in the measurement region, the case where the paper P has a high optical transmittance and the case where the paper P is not present in the measurement region are distinguished from each other more accurately than the case where presence or absence of the paper P is determined without contact.

Furthermore, in this exemplary embodiment, in the case where the processor 81 performs, based on the transmittance of ultrasonic waves of the paper P, the determination as to whether not a measurement target is present in the measurement region, the burden on the paper P is reduced compared to the case where presence or absence of the paper P is determined with contact.

Furthermore, in this exemplary embodiment, in the case where the processor 81 performs, based on the optical transmittance and the transmittance of ultrasonic waves, the determination as to whether the paper P is an object with a high optical transmittance or the paper P is not present in the measurement region, the case where the paper P has a high optical transmittance and the case where the paper P is not present in the measurement region are distinguished from each other while the burden on the paper P being reduced compared to the case where presence or absence of the paper P is determined with contact.

Furthermore, in this exemplary embodiment, the color of the paper P is determined based on the wavelength and the strength of light received by the color measuring unit 30 including the light radiating part 32 that emits light of different wavelengths. Thus, the device configuration is simplified compared to a configuration in which multiple light radiating parts that radiate light of different wavelengths are provided.

Furthermore, in the case where the color measuring unit 30, the ultrasonic wave measuring unit 40, the transmitted light measuring unit 50, and the resistance measuring unit 60 are provided on a transport path for the paper P as in this exemplary embodiment, the case where the paper P has a high optical transmittance and the case where the paper P is not present in the measurement region are distinguished from each other consecutively.

Furthermore, in this exemplary embodiment, in the case where the result of the determination based on the electrical resistance of the paper P as to whether or not the paper P is present in the measurement region and the result of the determination based on the transmittance of ultrasonic waves of the paper P as to whether or not the paper P is present in the measurement region are different, the processor 81 compares the measurement position for the electrical resistance with the measurement position for the transmittance of ultrasonic wave in the measurement region and determines the order of priorities of the electrical resistance and the transmittance of ultrasonic waves. Thus, in this exemplary embodiment, presence or absence of the paper P in the measurement region is determined more accurately than the case where a predetermined measurement method is given priority irrespective of the measurement position for the electrical resistance and the measurement position for the transmittance of ultrasonic waves.

Furthermore, in the case where, as in this exemplary embodiment, the processor 81 compares the measurement position for the electrical resistance with the measurement position for the transmittance of ultrasonic waves in the measurement region and priority is given to the measurement position that is located closer to the side opposite the set direction A from which the paper P is set into the set part SR, presence or absence of the paper P in the measurement region is determined more accurately than the case where the measurement position for the electrical resistance and the measurement position for the transmittance of ultrasonic waves are compared with each other and priority is given to the measurement position that is located closer to the set direction A.

Furthermore, in this exemplary embodiment, when acquiring an image forming instruction from the operation unit 18, the control device 16 acquires information on the paper P from the measuring device 20. The control device 16 causes the image forming unit 14 and the transport mechanism 15 to perform an image forming operation and controls, based on measured value information, the operation of the image forming unit 14 and the transport mechanism 15. Thus, the quality of an image formed on the paper P is improved compared to the case where the user sets the color or the optical transmittance of the paper P and performs printing.

### OTHER EMBODIMENTS

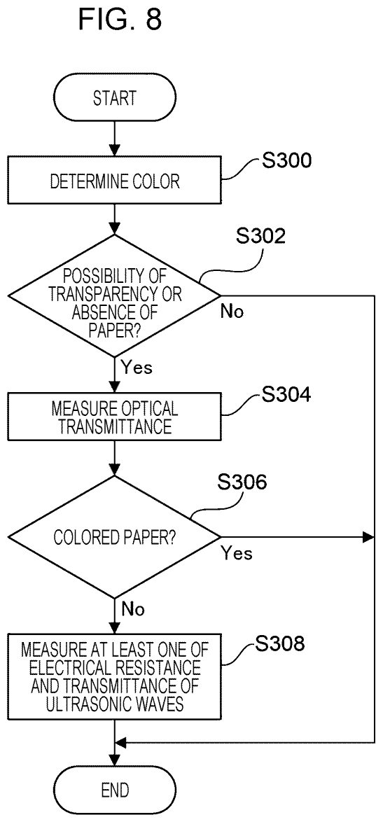

In the exemplary embodiment described above, the control circuit 80 performs the control process, as illustrated in FIG. 5. However, the present disclosure is not limited to the configuration described above. For example, a control process may be performed as illustrated in FIG. 8.

As illustrated in FIG. 8, in step S300, the processor 81 drives the color measuring unit 30 to obtain the color of the paper P. Specifically, the color of the paper P is determined based on reflection light by the paper P.

Next, in step S302, the processor 81 determines whether or not there is a possibility that the paper P may be transparent or the paper P may be not present in the measurement region. Specifically, in the case where the color measured by the color measuring unit 30 and the color of the opposing surface 21A are the same, it is determined that there is a possibility that the paper P may be transparent or the paper P may be not present in the measurement region. In the case where it is determined that there is a possibility that the paper P may be transparent or the paper P may be not present in the measurement region, the processor 81 proceeds to step S304. In the case where it is determined that there is no possibility that the paper P may be transparent or the paper P may be not present in the measurement region, the processor 81 stores the color measured by the color measuring unit 30 into the memory 82 or the storage 83 and ends measurement of the paper P.

Next, in step S304, the processor 81 drives the ultrasonic wave measuring unit 40 to obtain the optical transmittance of the paper P.

Next, in step S306, the processor 81 determines, based on the optical transmittance, whether or not the paper P is colored paper. In the case where it is determined that the paper P is not colored paper, the processor 81 proceeds to step S308. In the case where it is determined that the paper P is colored paper, the processor 81 stores the color measured by the color measuring unit 30 into the memory 82 or the storage 83 and ends measurement of the paper P.

Next, in step S308, the processor 81 drives at least one of the ultrasonic wave measuring unit 40 and the resistance measuring unit 60 to determine whether or not the paper P is present in the measurement region. In the case where the determination result is that the paper P is not present, the processor 81 causes the operation unit 18 to display, for example, an error message indicating that the paper P is not present. In contrast, in the case where the determination result is that the paper P is present, it is determined that the paper P is paper that is not colored paper. The processor 81 stores the result of the determination into the memory 82 or the storage 83 and ends measurement of the paper P.

In the case of the control process illustrated in FIG. 8, when it is determined, using the color measuring unit 30, that the paper P is colored paper, the processor 81 does not drive the ultrasonic wave measuring unit 40, the transmitted light measuring unit 50, or the resistance measuring unit 60. Thus, energy to be consumed for driving is suppressed.

Furthermore, in the case where the processor 81 acquires in advance the color of the opposing surface 21A as a holder and the acquired color of the opposing surface 21A matches the determined color of the paper P, the case where the paper P and the opposing surface 21A have the same color, the case where the paper P is an object with a high optical transmittance, and the case where the paper P is not present in the measurement region are distinguished from one another.

In the exemplary embodiment described above, a recording medium is used as an example of a measurement target. However, the measurement target is not limited to a recording medium. For example, the measurement target may be used for a purpose other than image forming. Furthermore, although the paper P is used as an example of a recording medium in an exemplary embodiment, the recording medium is not limited to paper. For example, the recording medium may be a sheet-like recording medium such as a film made of metal or resin.

Although the measuring device 20 includes the ultrasonic wave measuring unit 40 and the resistance measuring unit 60 in an exemplary embodiment, the measuring device 20 does not necessarily include the ultrasonic wave measuring unit 40 and the resistance measuring unit 60. For example, the measuring device 20 may include only one of the ultrasonic wave measuring unit 40 and the resistance measuring unit 60. Furthermore, the measuring device 20 does not necessarily include the color measuring unit 30.

The present disclosure is not limited to the exemplary embodiments described above. Various modifications, changes, and improvements may be made to the foregoing exemplary embodiments without departing from the gist of the present disclosure. For example, modifications described above may be combined in an appropriate manner.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1))

A measuring system comprising:
a first light emitter that emits light toward a measurement target;
a first light receiver that receives light transmitted through the measurement target;
a measuring unit that measures at least one of an electrical resistance and a transmittance of ultrasonic waves of the measurement target; and
a processor configured to:
   determine, based on a size of the light received by the first light receiver and a result of measurement by the measuring unit, whether or not the measurement target is an object with a high optical transmittance or whether or not the measurement target is present in a measurement region.

(((2)))

The measuring system according to (((1))),
wherein the measuring unit includes a power source and a pair of electrodes that applies a voltage to the measurement target, and
wherein the processor is configured to determine, based on the electrical resistance of the measurement target, whether or not the measurement target is present in the measurement region.

(((3)))

The measuring system according to (((2))),
wherein the processor is configured to determine, based on the size of the light received by the first light receiver and the electrical resistance, whether the measurement target is an object with a high optical transmittance or the measurement target is not present in the measurement region.

(((4)))

The measuring system according to any one of (((1))) to (((3))),
wherein the measuring unit includes an emitter that emits ultrasonic waves toward the measurement target and a receiver that receives ultrasonic waves transmitted through the measurement target, and
wherein the processor is configured to determine, based on the transmittance of ultrasonic waves of the measurement target, whether or not the measurement target is present in the measurement region.

(((5)))

The measuring system according to (((4))), wherein the processor is configured to determine, based on the size of the light received by the first light receiver and the transmittance of ultrasonic waves, whether the measurement target is not present in the measurement region or the measurement target is an object with a high optical transmittance.

(((6)))

The measuring system according to any one of (((1))) to (((5))), further comprising:
a second light emitter that emits light of different wavelengths toward the measurement target; and
a second light receiver that receives light reflected by the measurement target,
wherein the processor is configured to determine, based on a wavelength and a strength of the light received by the second light receiver, a color of the measurement target.

(((7)))

The measuring system according to (((6))),
wherein a holder that holds the measurement target is arranged, and
wherein the processor is configured to, in a case where a color of the holder is acquired in advance and the acquired color of the holder and the determined color of the measurement target match, determine, based on the size of the light received by the first light receiver and the result of the measurement by the measuring unit, whether or not the measurement target is an object with a high optical transmittance or whether or not the measurement target is present in the measurement region.

(((8)))

The measuring system according to any one of (((1))) to (((7))), further comprising:
a transport unit that transports the measurement target,
wherein the first light emitter, the first light receiver, and the measuring unit are provided on a transport path for the measurement target.

(((9)))

The measuring system according to (((1))),
wherein the measuring unit includes
   a power source,
   a pair of electrodes that applies a voltage to the measurement target,
   an emitter that emits ultrasonic waves toward the measurement target, and
   a receiver that receives ultrasonic waves transmitted through the measurement target, and
wherein the processor is configured to, in a case where a result of a determination based on the electrical resistance of the measurement target as to whether or not the measurement target is present in the measurement region and a result of a determination based on the transmittance of ultrasonic waves of the measurement target as to whether or not the measurement target is present in the measurement region are different, compare a measurement position for the electrical resistance with a measurement position for the transmittance of ultrasonic waves in the measurement region and determine an order of priorities of the electrical resistance and the transmittance of ultrasonic waves.

(((10)))

The measuring system according to (((9))), further comprising:
a set part into which the measurement target, which has a sheet-like shape, is set,
wherein the processor is configured to compare the measurement position for the electrical resistance with the measurement position for the transmittance of ultrasonic waves in the measurement region and give priority to a measurement position that is located closer to a side opposite a set direction from which the measurement target is set into the set part.

(((11))) An image forming system comprising:
the measuring system according to any one of (((1))) to (((10))); and
an image forming unit that forms an image on a recording medium as the measurement target whose color or optical transmittance has been measured by the measuring system.

What is claimed is:

1. A measuring system comprising:
a first light emitter that emits light toward a measurement target;
a first light receiver that receives light transmitted through the measurement target;
a measuring unit that measures at least one of an electrical resistance and a transmittance of ultrasonic waves of the measurement target; and
a processor configured to:
determine, based on a size of the light received by the first light receiver and a result of measurement by the measuring unit, whether or not the measurement target is an object with a high optical transmittance or whether or not the measurement target is present in a measurement region.

2. The measuring system according to claim 1,
wherein the measuring unit includes a power source and a pair of electrodes that applies a voltage to the measurement target, and
wherein the processor is configured to determine, based on the electrical resistance of the measurement target, whether or not the measurement target is present in the measurement region.

3. The measuring system according to claim 2, wherein the processor is configured to determine, based on the size of the light received by the first light receiver and the electrical resistance, whether the measurement target is an object with a high optical transmittance or the measurement target is not present in the measurement region.

4. The measuring system according to claim 1,
wherein the measuring unit includes an emitter that emits ultrasonic waves toward the measurement target and a receiver that receives ultrasonic waves transmitted through the measurement target, and
wherein the processor is configured to determine, based on the transmittance of ultrasonic waves of the measurement target, whether or not the measurement target is present in the measurement region.

5. The measuring system according to claim 4, wherein the processor is configured to determine, based on the size of the light received by the first light receiver and the transmittance of ultrasonic waves, whether the measurement target is not present in the measurement region or the measurement target is an object with a high optical transmittance.

6. The measuring system according to claim 1, further comprising:
a second light emitter that emits light of different wavelengths toward the measurement target; and
a second light receiver that receives light reflected by the measurement target,
wherein the processor is configured to determine, based on a wavelength and a strength of the light received by the second light receiver, a color of the measurement target.

7. The measuring system according to claim 6,
wherein a holder that holds the measurement target is arranged, and
wherein the processor is configured to, in a case where a color of the holder is acquired in advance and the acquired color of the holder and the determined color of the measurement target match, determine, based on the size of the light received by the first light receiver and the result of the measurement by the measuring unit, whether or not the measurement target is an object with a high optical transmittance or whether or not the measurement target is present in the measurement region.

8. The measuring system according to claim 1, further comprising:
a transport unit that transports the measurement target,
wherein the first light emitter, the first light receiver, and the measuring unit are provided on a transport path for the measurement target.

9. The measuring system according to claim 1,
wherein the measuring unit includes
a power source,
a pair of electrodes that applies a voltage to the measurement target,
an emitter that emits ultrasonic waves toward the measurement target, and
a receiver that receives ultrasonic waves transmitted through the measurement target, and
wherein the processor is configured to, in a case where a result of a determination based on the electrical resistance of the measurement target as to whether or not the measurement target is present in the measurement region and a result of a determination based on the transmittance of ultrasonic waves of the measurement target as to whether or not the measurement target is present in the measurement region are different, compare a measurement position for the electrical resistance with a measurement position for the transmittance of ultrasonic waves in the measurement region and determine an order of priorities of the electrical resistance and the transmittance of ultrasonic waves.

10. The measuring system according to claim 9, further comprising:
a set part into which the measurement target, which has a sheet-like shape, is set,
wherein the processor is configured to compare the measurement position for the electrical resistance with the measurement position for the transmittance of ultrasonic waves in the measurement region and give priority to a measurement position that is located closer to a side opposite a set direction from which the measurement target is set into the set part.

11. An image forming system comprising:
the measuring system according to claim 1; and
an image forming unit that forms an image on a recording medium as the measurement target whose color or optical transmittance has been measured by the measuring system.

12. An image forming system comprising:
the measuring system according to claim 2; and
an image forming unit that forms an image on a recording medium as the measurement target whose color or optical transmittance has been measured by the measuring system.

13. An image forming system comprising:
the measuring system according to claim 3; and
an image forming unit that forms an image on a recording medium as the measurement target whose color or optical transmittance has been measured by the measuring system.

14. An image forming system comprising:
the measuring system according to claim 4; and
an image forming unit that forms an image on a recording medium as the measurement target whose color or optical transmittance has been measured by the measuring system.

15. An image forming system comprising:
the measuring system according to claim 5; and
an image forming unit that forms an image on a recording medium as the measurement target whose color or optical transmittance has been measured by the measuring system.

16. An image forming system comprising:
the measuring system according to claim 6; and
an image forming unit that forms an image on a recording medium as the measurement target whose color or optical transmittance has been measured by the measuring system.

17. An image forming system comprising:
the measuring system according to claim 7; and
an image forming unit that forms an image on a recording medium as the measurement target whose color or optical transmittance has been measured by the measuring system.

18. An image forming system comprising:
the measuring system according to claim 8; and
an image forming unit that forms an image on a recording medium as the measurement target whose color or optical transmittance has been measured by the measuring system.

19. An image forming system comprising:
the measuring system according to claim 9; and
an image forming unit that forms an image on a recording medium as the measurement target whose color or optical transmittance has been measured by the measuring system.

20. An image forming system comprising:
the measuring system according to claim 10; and
an image forming unit that forms an image on a recording medium as the measurement target whose color or optical transmittance has been measured by the measuring system.
